(19) United States
(12) Patent Application Publication
(10) Pub. No.: US 2009/0174919 A1
(43) Pub. Date: Jul. 9, 2009

(54) Directed illumination diffraction optics auto-stereo display

(76) Inventor: Gaylord Moss, Marina del Rey, CA (US)

Correspondence Address: CARTER, DELUCA, FARRELL & SCHMIDT, LLP, 445 BROAD HOLLOW ROAD, SUITE 420, MELVILLE, NY, 11747, US

(21) Appl. No.: 12/317,835

(22) Filed: Dec. 29, 2008

Related U.S. Application Data
(60) Provisional application No. 61/017,331, filed on Dec. 28, 2007.
(60) Provisional application No. 61/099,785, filed on Sep. 24, 2008.

(51) Int. Cl. G03H 1/26; G02B 27/22

(52) U.S. Cl. 359/23; 359/464

(57) ABSTRACT

A display device includes a surface configured to be illuminated by at least two directed light beams, and one or more holographic optical elements. The surface is configured and disposed with respect to the holographic optical element to display an autostereo image that is illuminated by the directed light beams wherein the holographic element diffracts the directed light beams to form separate stereo viewing areas. The surface and the holographic optical element may be configured and oriented with respect to each other to enable the directed light beams to be alternately switched in synchronization with left and right stereo images presented on the surface to yield an autostereo view to one or more observers.

### CROSS-REFERENCE TO RELATED APPLICATIONS

This application claims priority to U.S. Provisional Application No. 61/017,331 by G. Moss et al., filed on Dec. 28, 2007, entitled “DIRECTED ILLUMINATION DIFFRACTION OPTICS AUTO-STEREO DISPLAY”, and to U.S. Provisional Application No. 61/099,785 by G. Moss et al., filed on Sep. 24, 2008, entitled “AUTOSTEREO DISPLAY SYSTEMS,” the entire contents of each of which being incorporated by reference herein.

### BACKGROUND

1. Technical Field

The present disclosure relates to video displays that provide stereo images for each eye of an observer.

2. Description of the Related Art

Current video displays provide the user a stereo image with separate images for each eye but require the user to wear polarized or other glasses or to peer into separate eyepieces as in a binocular microscope.

### SUMMARY

The present disclosure relates to a display device that includes a surface configured to be illuminated by two or more directed light beams and one or more holographic optical elements. The surface is configured and disposed with respect to the holographic optical element(s) to display an autostereo image that is illuminated by the two (or more) directed light beams. The holographic element(s) diffracts the two directed light beams to form separate stereo viewing areas.

In one embodiment, the surface is a light imaging surface made from a liquid crystal material. In another embodiment, the surface is configured and oriented with respect to the holographic optical element(s) to display the autostereo image that is illuminated in transmission or reflection by the two directed light beams. In still another embodiment, two or more holographic optical elements are bonded together or recorded in the same recording material. The holographic optical element may be recorded in one or more layers of recording material.

The holographic optical element(s) may be a transmission optical element or a reflection optical element. The holographic optical element may include one or more multiple holographic elements.

The holographic optical element(s) may be configured to form two or more viewing areas to allow multiple observers to simultaneously observe the autostereo image.

In yet another embodiment, the surface is a light-imaging surface containing the autostereo image and the holographic element(s) is manufactured and oriented so that the two directed light beams pass therethrough before or after passing through the light-imaging surface.

The surface may include a light-imaging surface wherein the one or more holographic optical elements is a reflection holographic optical element that reflects the directed light beams through the light-imaging surface. The surface may also be a reflecting image surface that reflects the two directed light beams through the holographic optical element (s). The holographic optical element(s) may include at least two holographic optical elements constructed of a different recording material to diffract different wavelength spectrums.

In another embodiment, a micro-structured flat panel and/or a holographic flat panel is configured to emit the two or more directed light beams. In yet another embodiment, a waveguide is configured and oriented with respect to the surface and the two holographic optical elements, wherein illumination by the two directed light beams is generated from multiple reflections formed inside the waveguide and the two directed light beams are partially diffracted by the holographic optical element(s) when the two directed light beams reflect beyond a cutoff. The two directed light beams may be configured to repeatedly reflect from the partially diffracting one or more holographic optical elements. The one or more holographic optical elements may be configured such that the efficiency varies to create uniform illumination along a length thereof.

In still yet another embodiment, a lens may be included that is configured and oriented to spread the two or more directed light beams to the width of the area of the image. A curved mirror may be configured and oriented to collimate the spread of the two directed light beams and direct the spread of the two directed light beams to the holographic optical element(s) for diffraction thereof by the holographic optical element(s) to form the separate stereo viewing areas. One or more arrays of directional light sources may be manufactured and oriented with respect to the surface and the holographic optical element(s) such that the two directed light beams originate from the one or more flat arrays of directional light sources.

The surfaces and the holographic optical element(s) may be configured and oriented with respect to each other to enable the two directed light beams to be alternately switched in synchronization with left and right stereo images presented on the surfaces to yield an autostereo view to one or more observers.

The present disclosure also relates to a method of displaying a stereoscopic image and includes the steps of: displaying a first image on a transparent display; illuminating the first image by projecting light onto a first hologram that directs the illumination though the transparent display to focus the first image at a viewing area; terminating the first image display and the illumination of the first image; displaying a second image on the transparent display; illuminating the second image by projecting light onto a second hologram that directs the light through the transparent display and focuses the second image at a second viewing area; and sequentially repeating the above steps at a refresh rate to provide a stereo image to an observer positioned to have one eye in the first viewing area and the other eye positioned in the second viewing area. In one embodiment, the refresh rate of each image is at least 60 Hz. The method may also include the step of activating each illumination beam at the same time that the corresponding image is displayed. In one method this may require that the illumination beam be both synchronized with the corresponding image and refreshed at the same rate as the image.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 illustrates the principles of a display device according to the present disclosure in which Illumination beams are arranged to illuminate a diffraction element that includes two separate holographic optical elements bonded together;

FIG. 2A illustrates a plan view of one embodiment of a directed illumination display device according to the present disclosure that includes a display panel that is a transmissive liquid crystal display;

FIG. 2B illustrates a side view along the width of the directed illumination display device of FIG. 2A;

FIG. 2C illustrates a side view along the length of the directed illumination display device of FIG. 2A;

FIG. 3A illustrates a plan view of one embodiment of a display device according to the present disclosure that is similar to the display device of FIG. 2 except that light is coupled directly into the ends of a substrate on which the holographic optical elements are recorded in a recording film;

FIG. 3B illustrates a side view along the width of the directed illumination display device of FIG. 3A;

FIG. 3C illustrates a side view along the length of the directed illumination display device of FIG. 3A;

FIG. 4 illustrates an optical setup for exposing a reflection holographic optical element according to the present disclosure;

FIG. 5A illustrates how the reflection holographic optical element of FIG. 4 is positioned to record a hologram prior to playback;

FIG. 5B illustrates the playback of the holographic optical element of FIG. 5A in which a beam Illuminates the holographic optical element that reconstructs the light in a diffuse panel;

FIG. 6A illustrates an example of transmission edge coupling in another embodiment of a display device in a simplified view according to the present disclosure;

FIG. 6B illustrates the edge coupling of FIG. 6A wherein the light from a first and a second beam is diffracted into the area in front of the left eye and into the area in front of the right eye of an observer, respectively;

FIG. 7A illustrates an example of reflection edge coupling in another embodiment of a display device in a simplified view according to the present disclosure;

FIG. 7B illustrates the edge coupling of FIG. 7A wherein the light from a first and a second beam is diffracted into the area in front of the left eye and into the area in front of the right eye of an observer, respectively;

FIG. 8A illustrates a side view of one embodiment of a directed illumination display device in a simplified view according to the present disclosure which employs a laser array image source;

FIG. 8B illustrates a plan view of the directed illumination display device of FIG. 8A;

FIG. 8C illustrates a flat panel light source array for the directed illumination display device of FIGS. 8A and 8B;

FIG. 9A illustrates a side view of one embodiment of a directed illumination display device according to the present disclosure in which a single hologram provides two stereo imaging areas;

FIG. 9B illustrates a plan view of the directed illumination display device of FIG. 9A;

FIG. 10A illustrates a plan view of one embodiment of a directed illumination display device according to the present disclosure in which an image is formed by a scanner on a holographic element;

FIG. 10B illustrates a side view of the directed illumination display device of FIG. 10A;

FIG. 10C illustrates a front view right eye scan of the directed illumination display device of FIG. 10A;

FIG. 10D illustrates a front view left eye scan of the directed illumination display device of FIG. 10A;

FIG. 11A illustrates a stacking order for a transmission directed illumination display device in which the illumination beams pass through the display panel before reaching the diffraction elements;

FIG. 11B illustrates a stacking order for the transmission directed illumination display device of FIG. 1 in which the illumination beams pass through the diffraction elements before reaching the display panel;

FIG. 12A illustrates a side view of one embodiment of a directed illumination display device according to the present disclosure that is configured in an optical arrangement in which a folded optical path provides directed beams to illuminate two holograms; and

FIG. 12B illustrates a plan view of the directed illumination display device of FIG. 12A.

### DETAILED DESCRIPTION

Embodiments of the presently disclosed viewing system are described herein below with reference to the accompanying drawing figures wherein like reference numerals identify similar or identical elements. In the following description, well-known functions or constructions are not described in detail to avoid obscuring the disclosure in unnecessary detail.

This disclosure describes an image display that uses a directed illumination system to transform a two-dimensional reflection or transmission display panel into an auto-stereo display. That is, a display that gives the user a stereo image with separate images for each eye without the necessity of wearing polarized or other glasses or of having to peer into separate eyepieces as in a binocular microscope.

A principle objective of the display is to illuminate a reflection or transmission display panel with two light beams that correlate to the reference beams for a diffraction optical element which, in turn, is designed to diffract these beams into separate viewing areas that match or correspond to the relative position of an observer's eyes. The diffraction element may be made so that the diffracted light from each illuminated point on the display image plate diffracts uniformly into one or the other of two viewing areas depending on which beam illuminates the panel. In operation, different images are sent to each viewing area to give a stereo view to an observer positioned in a manner that each eye is in a different viewing area. The illumination beams that are projected (or that otherwise illuminate the panels) do not contain any of the image information. The image is formed on the panel independently of the illumination. Thus, if the image-forming panel is a liquid crystal display, it may be illuminated with a distorted projection illumination beam without causing observable distortion or aberration in the image viewed by the observer. The directed illumination functions solely to direct the light from the correct stereo image to the appropriate eye.

### Description of the Directed Illumination System

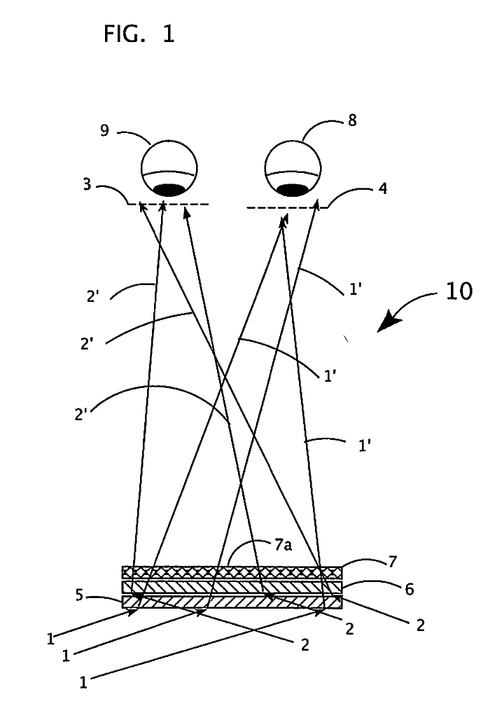

One embodiment of the basic principle of illuminating a reflection or transmission display panel with two light beams that correlate to the reference beams for a diffraction optical element is shown in FIG. 1. For a simplified display device 10 according to the present disclosure, illumination beams 1 and 2 are projected to illuminate the diffraction element that may include one or more separate holographic optical elements 5 and 6, alternatively referred to herein as holograms 5 and 6, bonded together, as shown, or two holograms recorded in a single film. In FIG. 1, two directed light or illumination beams 1 and 2 are the reference beams for holograms 5 and 6 that generate diffracted object beams 1′ and 2′. Illumination beam 1 illuminates hologram 5 to diffract light 1′ into viewing area 4. Illumination beam 2 illuminates hologram 6 to diffract light 2′ into viewing area 3. The diffracted light 1′, 2′ is diffused so that the light from each point on the image plane is spread uniformly into viewing area 4 if the illumination is from beam 1 or into viewing area 3 if the illumination is from beam 2.

In FIG. 1, for the transmission hologram 5 and 6, the light diffracted into areas 3 and 4 has passed through the transparent image layer 7 or surface 7a illuminating the image on image layer or surface 7a to the observer's eyes, 8 and 9. If the illumination beams 1 and 2 are both turned “on”, then the transparent image on the display screen will be visible to each eye 8 and 9 of an observer. In order for an observer to see a stereo image, each eye 8 and 9 must see the appropriate image of the 3-D scene as it would be seen from the location of that particular eye 8 and/or 9.

As can be appreciated from the foregoing description, the display device 10 includes surface 7 that is configured to be illuminated by two or more directed light beams, e.g., illumination beams 1 and 2, and at least one holographic optical element, e.g., holograms 5 and/or 6. The surface 7 is configured and oriented with respect to one or more holographic optical elements 5 and/or 6 to display an autostereo image (not shown) that is illuminated by the two directed light beams 1 and 2. At least one the holographic elements 5 and 6, diffracts the two directed light beams 1 and 2 to form separate stereo viewing areas 3 and 4.

Unless otherwise noted, the display devices described hereinafter are assumed to be configured in the foregoing manner.

As discussed in more detail below, surface 7a may be a light-imaging surface made from a liquid crystal material. Further, surface 7a may be configured and oriented with respect to the one or more holographic optical elements 5 and 6 to display the autostereo image illuminated either in transmission as shown in FIG. 1 or in reflection by the illumination beams 1 and 2. The two holographic optical elements 5 and 6 may be bonded together and may be a transmission optical element and/or a reflection optical element. Holographic optical element 5 or 6 may include at least one multiple holographic optical element and may be recorded in one or more layers of recording material.

It should be noted also that although the observer represented by eyes 8 and 9 is illustrated as a human being, the observer could also be an animal or also the eye of a motion picture or television camera or the like, in which case more than one camera may be required each with separate circuitry to detect the stereo image. Display devices according to the present disclosure may also be configured to provide two or more viewing areas wherein the holographic optical element 5 or 6 is configured to allow at least two observers to simultaneously observe the autostereo image.

### The Auto-Stereo Function

The present disclosure describes two methods for presenting a separate image to each eye for an auto-stereo image summarized as follows: a) using anaglyph images; or b) rapidly switching between alternate left and right eye images synchronized with left and right eye illumination.

One example of an anaglyph display system may include one of the illumination beams being red and the other being cyan and a display panel that is arranged to show the combined red and cyan anaglyph images. The illumination sources would continuously illuminated and the red image would be directed to one eye and the cyan image to the other eye so that the user would see anaglyph stereo imagery without the necessity of wearing colored anaglyph glasses.

In another technique (technique “b” summarized above) an example of a full color display is described wherein both illumination beams are full color, either white or a combination of colors such as red, green and blue to make up the desired color temperature of the image. The left and right eye stereo images are alternated on the display panel with the two illumination beams alternated in synchronism so that each eye sees the appropriate stereo image. The images are switched fast enough to eliminate flicker in the observed image. In FIG. 1, when the illumination beam 1 is on, the image displayed is that of the left stereo view and the light through the display is diffracted to the left eye. Similarly, when the illumination beam 2 is on, the image displayed is that of the right stereo view and the light through the display is diffracted to the right eye. In this instance, the observer sees an autostereo image as a result of the diffraction of the appropriate stereo view image light to the appropriate eye.

Example with Lens and Mirror Illumination

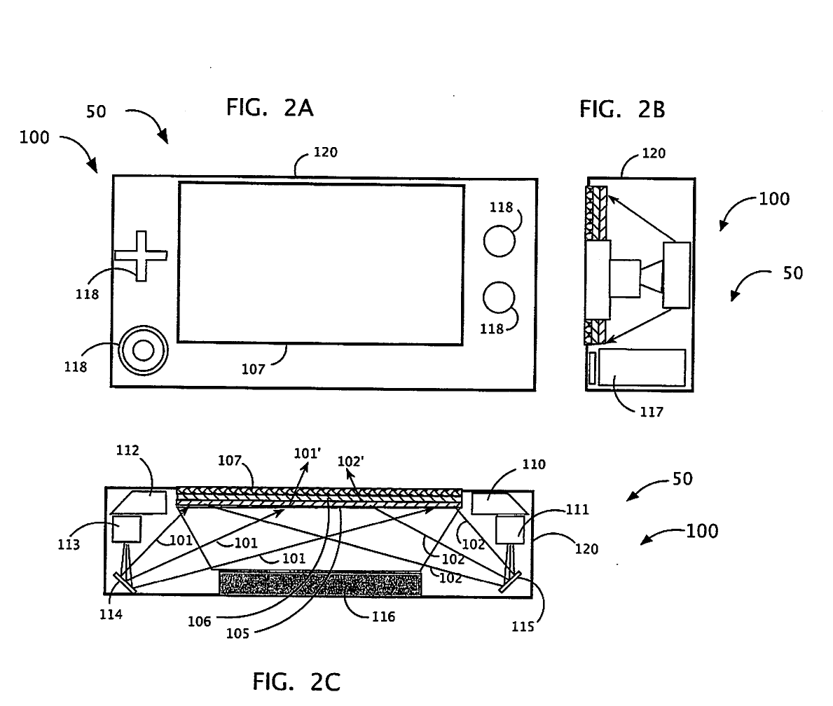

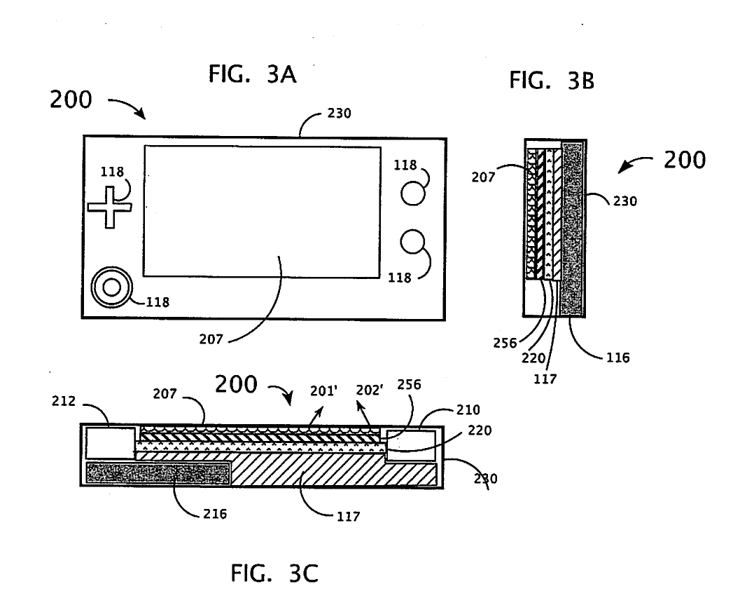

A sketch of an example implementation or embodiment of the present disclosure is shown in FIG. 2. FIG. 2 shows one example of a lens and mirror illumination system 50 and includes a display panel 100 having a transmission liquid crystal display 107. Light sources 110 and 112 are included that may be constructed of solid-state light emitting diodes (LEDs), laser diodes of other commonly known light emitting sources. Light sources 110 and 112 may each be a combination of three (3) or more color sources capable of making a full color spectrum or a single white light source. Lenses 111 and 113 are included that have a cylindrical component configured to spread a light beam more widely in a given direction to properly illuminate the holograms 105 and 106. Mirrors 114 and 115 are also included that are oriented to reflect illumination beams 101 and 102 to the holograms 105 and 106, respectively. The diffracted beams 101′ and 102′ pass through the liquid crystal display 107 to form the stereo viewing pupils 3 and 4 as shown in FIG. 1. The un-diffracted or zero-orders of the illumination beams are not visible from the viewing areas 3 and 4. Plastic or glass prism 119 is included to prevent reflection of beams 101 and 102 from the surface of hologram 105. The ancillary components of the display, e.g., battery 116, electronics 117 and control switches 118 are placed in the remaining spaces in case 120 to compete the system. Example with Edge-Coupled Illumination FIG. 2. illustrates a technique to illuminate the holograms 105 and 106 directly with impinging directed beams 101 and 102. As shown in FIG. 3, display device 200 according to the present disclosure provides a technique for coupling the illumination through the edge of a hologram 256. Hologram 256 is a hologram formed by recording holograms 5 and 6 of FIG. 1 in the same plate or in the same recording material. In this instance, the light from light sources 210 and 212 is coupled through the edge of a thin plate 220 that carries the light along the surface of the holographic optical element or hologram 256 before reaching the liquid crystal display or surface 207 and passing through as beams 201′ and 202′ separately to each eye of an observer (not shown). Such methods are well known and have been used in illuminating pictorial holograms and provide a way to reduce the thickness of the hologram and illumination system.

Since the illuminating beams 1 and 2 (see FIG. 1) do not contain the image information, distortion in these beams is not important. Therefore, simple expansion optics may be used to spread or expand these beams 1 and 2 to cover the liquid crystal display 207. Thus, low cost molded aspheric mirrors may be used for elements or mirrors 114 and 115 (see FIG. 2), simplifying or replacing the lens elements 111 and 113 (see FIG. 2) that would otherwise be contained within the case 230 of the display device 200. The case 230 also includes known electronic circuitry and/or other components commonly grouped as element 117.

### Hologram Exposure Construction Optics

One of the advantages of the directed illumination system is that projection beam distortion does not affect the image quality in contrast to image projection systems in which any distortion in the projection is evident in the image. This allows simple, low-cost expansion optics such as a single molded mirror to be used for the projection system instead of complex multi-element lenses. In order to take advantage of the use of such simple projection optics for the replay reference beam, the same distorted beam that is used to replay the holographic element is used in construction thereof. This is most easily done by constructing or forming the hologram in two steps termed H1 and H2. The actual projection beam is used for constructing the hologram, rather than the inverse thereof as is customary for transmission holograms.

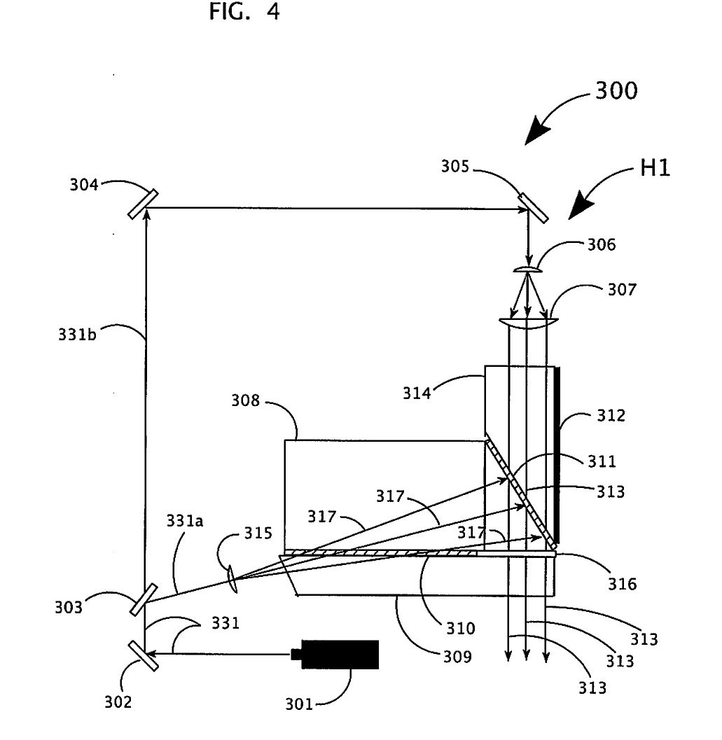

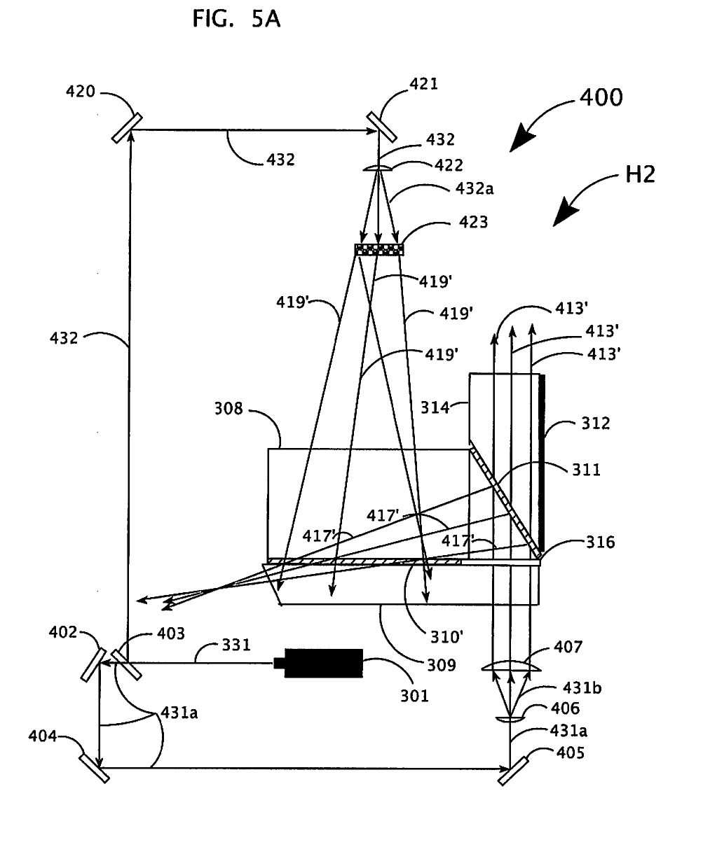

FIG. 4 shows the optical setup 300 for exposing H1. In this instance, a beam 331 from laser 301 is reflected by mirror 302 to beamsplitter 303 where part of the beam 331a is reflected to a simple expansion lens 315 to pass therethrough as beam 317. Beam 317 then projects into glass block 309 through glass plate 310, then through glass block 308 and through HI recording plate 311. Beam 331b which passed through beamsplitter 303 is reflected by mirrors 304 and 305 and is spread or expanded by lens 306, collimated by lens 307 and then passes into glass block 314 as collimated beam 313 to combine in H1 recording plate 311 with beam 317 to record the reflection hologram H1. Absorption layer 312 prevents reflected light from beam 317 from returning to record in recording plate or hologram H1 311. Glass blocks 308 and 309 are positioned on either side of glass plate 310 to prevent the recording light in beam 317 from being reflected from shallow angle surfaces in the recording of both H1 and H2. All the mating glass surfaces, such as those between glass block 308 and hologram 311, between hologram 311 and glass block 14, between glass block 308 and absorption layer 312, and between absorption layer 312 and glass plate 316 are index matched with a fluid to prevent reflections. Glass plate 316 fills the gap between glass blocks 308 and 309.

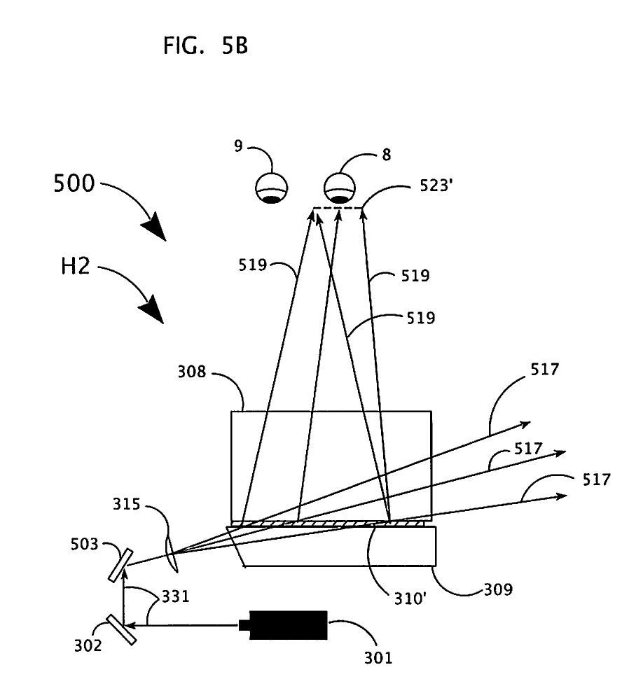

FIG. 5A shows optical setup 400 that indicates how Hi recording plate 311 is used to record hologram H2. Glass plate 310 in FIG. 4 is now replaced by a holographic recording plate 310′ of the same thickness as holographic recording plate 310. As shown, the light 331 from the laser 301 is split by beam-splitter 403 with the transmitted beam 431A reflected by mirrors 402, 404 and 405, then spread or expanded as beam 431 b by lens 406 and collimated by lens 407 to form beam 413′ that passes through reflection hologram H1 311 in the reverse direction than when it was recorded by beam 313 in FIG. 4. Hologram or recording plate H1 311 creates a beam 417′ that is the reverse of the reference beam 317 created by hologram or recording plate H1 311. The light 432 that is reflected by beam-splitter 403 is then reflected by mirrors 420 and 421, then spread or expanded as beam 432a by lens 422 to illuminate diffuser 423 that becomes the viewing pupil space in the auto-stereo system. Recording plate 310′ records the diffraction pattern between light 419′ from diffuser 423 and from projection beam 417′ that is the reverse of the projection beam 317.

FIG. 5B illustrates the optical setup 500 for playback of the holographic recording plate or optical element H2 310′. In a similar manner as the optical setup 300 illustrated in FIG. 4, beam 331 from laser 301 is reflected by mirror 302 (now to a mirror 503) where the beam 331 is reflected to a simple expansion lens 315 to pass as beam 517 into glass block 309. From the glass block 309, the beam projects through the holographic recording plate or optical element H2 310′ and on through glass block 308. Beam 517 illuminates the hologram H2 310′ that reconstructs the light 519′ in diffuse panel 523 as light 519. The light 519 from each point on the hologram H2 310′ is evenly distributed over the viewing area 523′. In order that the light illuminating the diffuser in playback come uniformly from the surface of the holographic recording plate or optical element H2 310′, the hologram diffraction efficiency must be varied over the surface area of the holographic recording plate or optical element H2 310′. This may be accomplished by using a spatial density variable filter over the beams during the construction exposure of holographic optical element H2 310′ or by pulling a mask over the exposure beams at a variable rate during exposure to vary the exposure time over different areas of the surface.

### Edge-Coupled Transmission Illumination

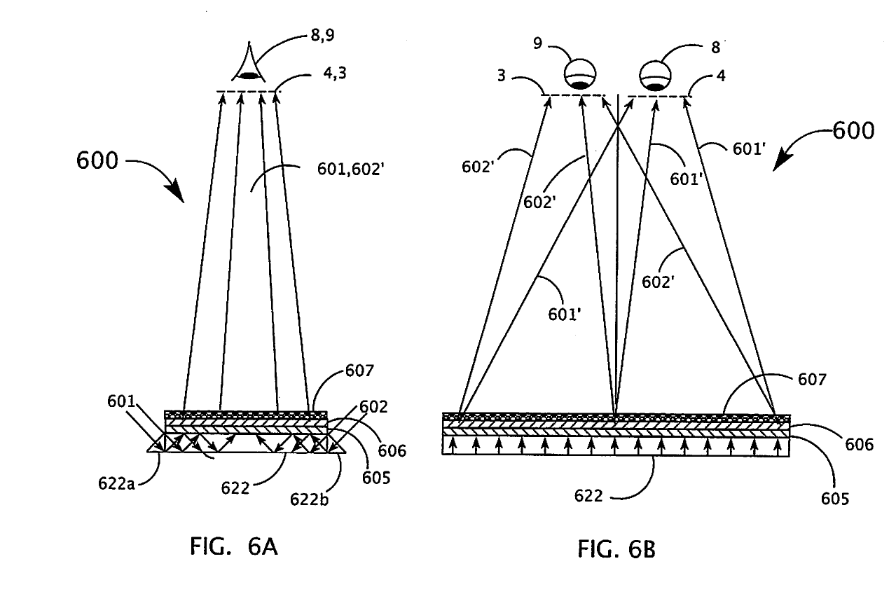

FIGS. 6A and 6B illustrate simplified views of one embodiment of a display device 600 according to the present disclosure. More particularly, FIGS. 6A and 6B illustrate one example of edge coupling for the directed illumination display device 600. Prisms 622a and 622b couple in beam 601 at one side 622a of coupling plate or waveguide 622 and beam 602 in the opposite side 622b of coupling plate or waveguide 622. Both beams 601 and 602 reflect at angles with total internal reflection so that they travel down inside plate 622 in opposite directions, e.g., beam 601 that travels from left to right in side view FIG. 6A. The hologram 605 diffracts a portion of beam 601 into diffuse beam 601′ each time beam 601 reflects onto hologram 605. As beam 601 travels left to right down coupling plate 622, beam 601 loses energy with each respective bounce. In order to keep the diffracted light of hologram 605 constant along a length thereof, the diffraction efficiency of hologram 605 increases from left to right. Thus, from left to right, as the light in beam 601 diminishes, the increased diffraction efficiency keeps the net light diffracted constant giving a uniform brightness along the length of the coupling plate 622. The diffraction efficiency of hologram 606 changes in the opposite direction, increasing from right to left in order to keep the diffracted light from beam 602 constant as it travels from right to left.

FIG. 6B shows light 601′ from beam 601, that has passed through liquid crystal display 607, diffracted into the area 4 in front of left eye 8 and the light 602′ from beam 602 is diffracted into the area 3 in front of right eye 9. Since light 601′ and 602′ is diffracted uniformly over the holograms 605 and 606, the illumination of the liquid crystal display 607 is uniform and the image on the display 607 is seen by either the left or right eye 8 or 9, respectively, depending on which illuminating beam is turned “on”. The stereo effect is created by alternating the left and right eye illumination in coordination with the left and right eye stereo images on the liquid crystal screen 607 so that the left eye sees the left eye stereo image and the right eye sees the right.

### Edge-Coupled Reflection Illumination

Although the previous examples of directed illumination display devices according to different embodiments of the present disclosure include transmission display panels, the basic principle of illuminating a display panel with two light beams that are the reference beams for a diffraction optical element as shown in FIG. 1 is also applicable to reflection display panels.

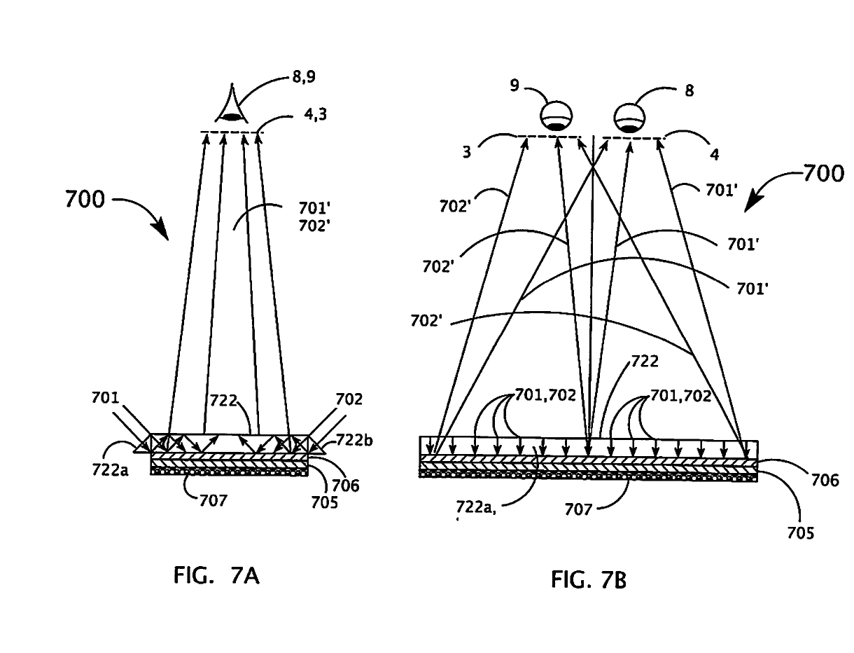

FIGS. 7A and 7B illustrate simplified views of one embodiment of a display device 700 according to the present disclosure that includes a reflection display panel 707. More particularly, FIG. 7 shows an example of reflection panel 707 that is illuminated by edge-coupled holograms 705 and 706. As shown, light beam 701 is coupled with a prism end or edge 722a of coupling channel or waveguide 722. The light 701 bounces beyond cutoff along the channel or waveguide 722, where the light 701 is uniformly diffracted as diffracted light 701′ into the area 4 for the left eye 8 in the same manner as that shown in FIGS. 6A and 6B. The light 701′ seen by the left eye 8 is modulated by the reflection image on the reflection image panel 707.

Similarly, light beam 702 is coupled with a prism end or edge 722b of coupling channel or waveguide 722 at an opposite side of the coupling channel or waveguide 722 with respect to prism end or edge 722a. The light 702 bounces beyond cutoff along the channel or waveguide 722, where the light 702 is uniformly diffracted as diffracted light 702′ into the area 3 for the right eye 8 in the same manner as that shown in FIGS. 6A and 6B. The light 702′ seen by the right eye 8 is also modulated by the reflection image on the reflection image panel 707. Thus, the right eye 9 sees the light 702′ in the area 3 illuminated by beam 702.

As illustrated in FIG. 5B, the observer sees stereo as the illumination beams 701 and 702 are switched “on” and “off” in synchronization with the left and right stereo images on the reflective display 707. In the same manner as for the transmission hologram above, the diffraction efficiency of the hologram is varied along the direction of illumination travel to keep the net diffracted light and hence brightness of the image constant over the surface of the image device.

Thus, the surface or reflective display 707 and the holographic optical elements 706 and 707 are configured and disposed with respect to each other to enable the directed light beams 701 and 702 to be alternately switched in synchronization with left and right stereo images presented on the surface 707 to yield an auto-stereo view to at least one observer.

### A Laser Array Auto-Stereo Display

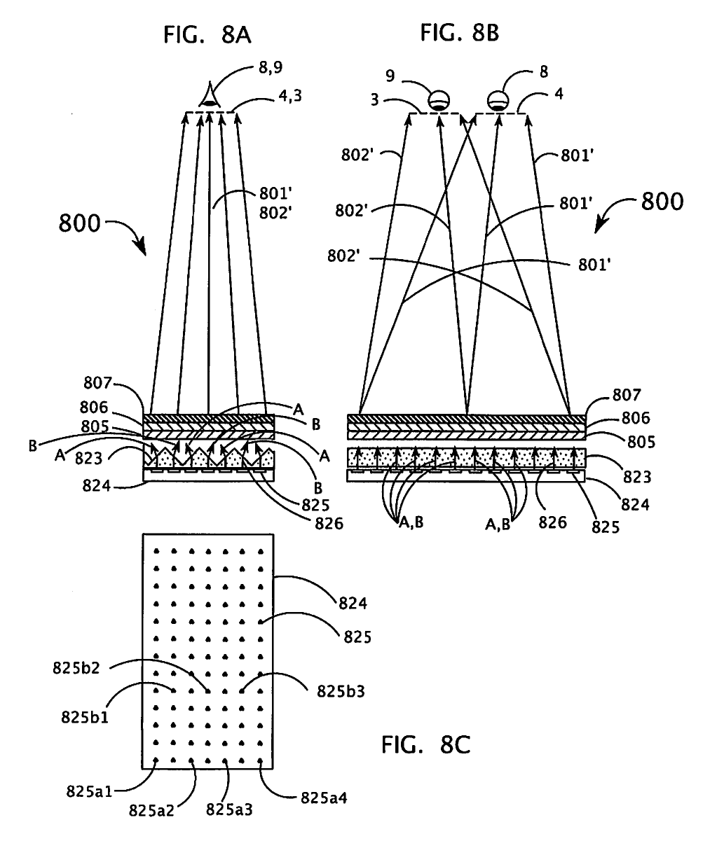

FIGS. 8A, 8B and 8C illustrate simplified views of another embodiment of a display device 800 according to the present disclosure that includes a laser array image source. More particularly, image plate 824 includes an array of full color sources 825 that may be, for example, triads of individual laser diodes. As shown, a micro-prism plate 823 matched to the positions of the laser diodes 825 directs alternate rows of diodes in two different directions corresponding to the directions of the reference beams 801′ and 802′ of the hologram plates 805 and 806. That is, alternate rows 825a1, 825a2, 825a3 and 825a4 of diodes 825 may be directed in a direction illustrated by arrows “A” that correspond to the direction of reference beam 801′ while alternate rows 825b1, 825b2 and 825b3 of diodes 825 may be directed in a direction illustrated by arrows “B” that correspond to the direction of reference beam 802′. The diffracted beams, 801′ and 802′ pass through the transmissive display or surface 807 to the viewing areas 4 and 3 in front of each observer's eye 8 and 9, respectively. By synchronizing alternate left and right images on the image display 807 with activation of alternate illumination beams 801 and 802, the observer with an eye in each viewing area 4 and 3 sees a full resolution auto-stereo image. Each eye sees the full resolution of the image display unlike lenticular or barrier displays which lose half the display resolution to generate two views.

Although the micro-prism 823 sends light in two alternate directions “A” and “B”, the light from adjacent rows, e.g., rows 825a1 and 825b1, etc., spreads enough to fully illuminate the complete area of the image screen or display 807. The resolution correlates to that of the image screen and not that of the illumination laser array and micro-prism illuminator.

The display device 800 may include a micro-structured flat panel, e.g., micro-prism plate 823, and/or a holographic flat panel configured to emit the two or more directed light beams represented by arrows “A” and “B”.

### A Single Hologram Diffraction Directed Illumination Display

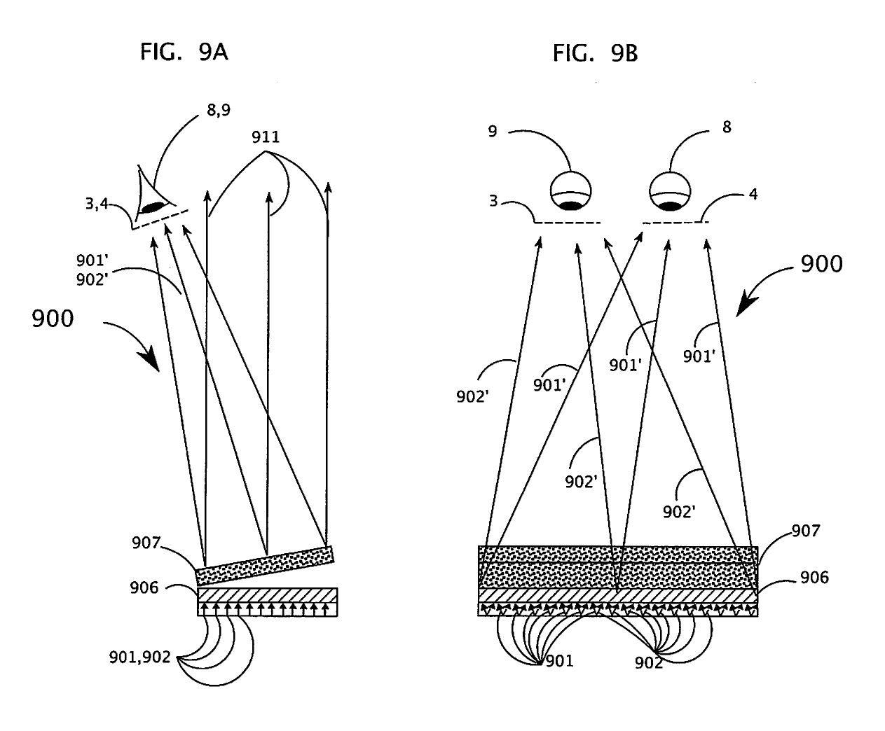

FIGS. 9A and 9B illustrate simplified views of another embodiment of a display device 900 according to the present disclosure and includes a single hologram that provides two stereo imaging areas. More particularly, FIGS. 9A and 9B show a display device 900 in which a single hologram provides two stereo imaging areas 3 and 4. As shown previously with respect to FIGS. 6A,6B and FIGS. 7A, 7B, edge coupling can provide a thin plate illuminator with two separate illumination beams, e.g., beams 601 and 602 over the surface of a hologram 606 in FIGS. 6A and 6B.

In contrast, the hologram is made with a single diffuse viewing area centered so that when two reference beams 901 and 902 are projected slightly offset from centered construction reference beam 911, two side-by-side viewing areas 3 and 4 are created by the diffraction of beams 901 and 902 by the single hologram 906. The transmission image source 907 is placed in the diffracted beams 901′ and 902′ perpendicular to the line-of-sight of the observer's eyes 8 and 9. Much like the embodiments described above, switching the illumination beams 901 and 902 in synchronization with the two stereo images on the image screen of the transmission image source 907 gives the observer a stereo view.

### A Scanning Display

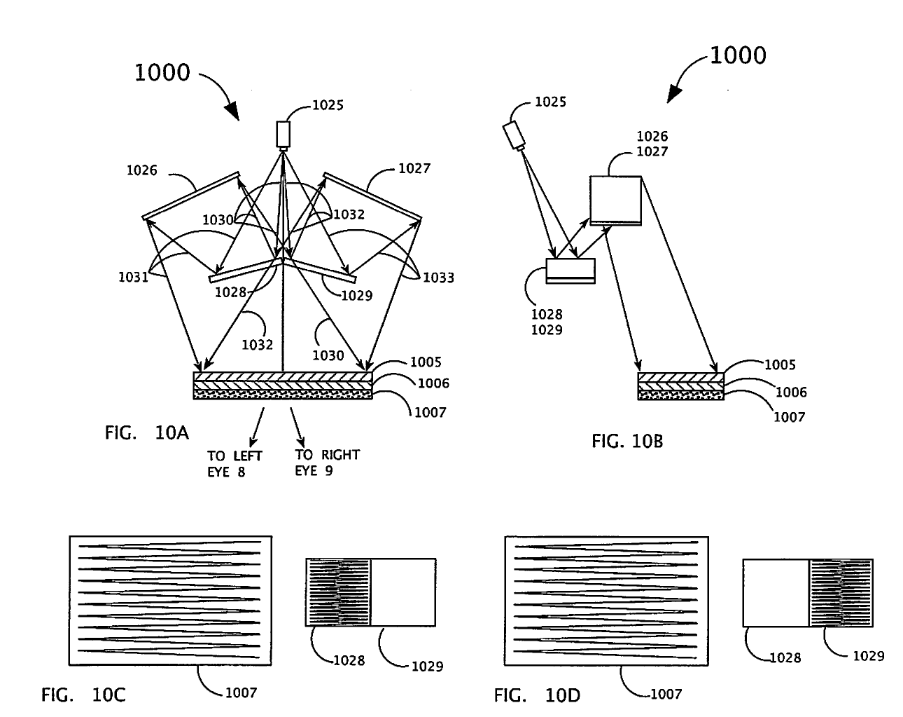

FIGS. 10A and 10B illustrate a directed illumination display device 1000 according to the present disclosure in which an image is formed by a scanner on a holographic optical element. FIG. 10C illustrates a front right eye scan produced by the directed illumination display device 1000. FIG. 10D illustrates a front left eye scan produced by the directed illumination display device 1000. More particularly, the directed illumination display device 1000 includes a scanning display 1007 in which directed beams 1030, 1031, 1032 and 1033 that illuminate the holograms 1005 and 1006 are generated by a single scanning beam from scanner 1025 and splitting mirrors 1028 and 1029 that direct the scanned beams 1030, 1031, 1032 and 1033 from the scanner 1025 in the two directions to correctly illuminate diffraction element 1005 to illuminate one eye 8 and diffraction element 1006 to illuminate the other eye 9. FIG. 10C shows the scan of a beam from scanner 1025 that makes a raster across the mirror 1028. Directed beam 1030 and 1031 from mirror 1026 provides the directed beam to illuminate hologram 1005 and diffract light illuminating the image for the right eye 9 in an image viewing pupil generated by hologram 1005. FIG. 10D shows the alternate scan on mirror 1029 which sends the directed illumination of beam 1032 and 1033 to mirror 1027 which, in turn, illuminates hologram 1006. Hologram 1006 directs illumination to the viewing pupil area for the left eye illuminating the left eye 8 to complete the autostereo effect.

### Stacking Order for Diffraction Optics and Image Display

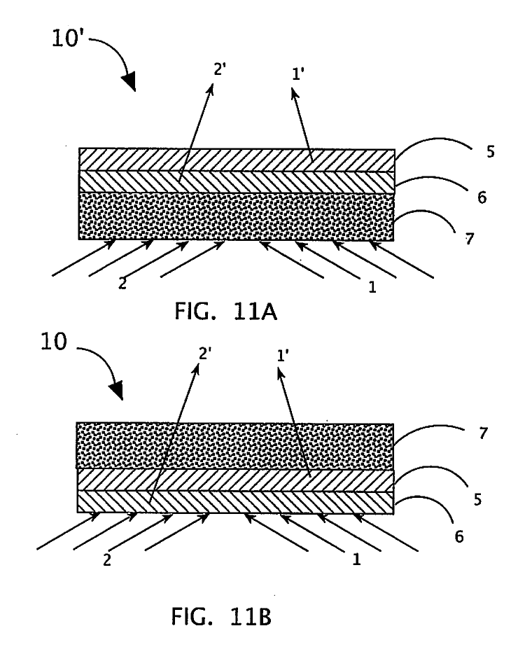

FIGS. 11A and 11B show two possible stacking orders for the main components in the simplified transmission directed display device 10 illustrated in FIG. 1 (i.e. the diffraction holographic optical elements 5 and 6 and the image display panel or surface 7 that contains the autostereo image).

In FIG. 11A, the display device 10′ is configured such that the illumination beams 1 and 2 pass through the display panel or surface 7 before reaching the diffraction elements 6 and 5 to produce the diffracted beams 1′ and 2′ respectively. That is, one or more holographic elements 5 or 6 are manufactured and oriented so that the two directed light beams 1 and 2 pass therethrough after passing through the light-imaging surface 7.

In FIG. 11B, the display device 10 is configured such that the illumination beams 1 and 2 pass through the diffraction elements 6 and 5 before going through the display panel or surface 7. That is, one or more holographic elements 5 or 6 are manufactured and oriented so that the two directed light beams 1 and 2 pass therethrough before passing through the light-imaging surface 7.

### Illumination Sources

One method to obtain a white light (in which the color balance can be adjusted) is to use three separate LEDs and to vary their brightness or switched “on” time. The three LEDs can be combined in a single package with the three emitters in close proximity or three separate LEDs can be combined with an array of color filters as is done in some digital projectors.

In another method, three solid state lasers can be combined to give full color. Depending on the illumination optical system, the three laser beams may need an arrangement of selective color filters to make the beams coaxial. Laser illumination has an advantage over LEDs as both edge coupling and hologram diffraction efficiency are increased. If the laser lines are narrow enough, there may need to be some dithering of the wavelengths to prevent speckle in the image.

### Methods to Switch Between 2-D and 3-D

The system can be instantly switched from 3-D to 2-D viewing by just switching input image signals so that each eye sees the same image. Another method is to make the left and right viewing areas wide enough so that both eyes of an observer fit into one area. Then, if the observer is centered, each eye sees a different image and the observer sees stereo. However, if the observer moves right or left, so that both eyes are in the same viewing area, he will see a monoscopic image.

In still another mode that eliminates the limited viewing area, a diffuser can be attached over the image screen showing a single image so that the scattered 2-D image light is viewable over a wide angle for a group of viewers. This diffuser can be could also be an electrically switchable diffuser layer such as used for privacy screens so that the switch from 3-D to wide 2-D could be instantaneous. A further option would be to add the diffuser, but keep both stereo images and use polarizers to filter the image and glasses to give wide-angle stereo viewing for groups of observers.

### Compact Collimating Illuminator

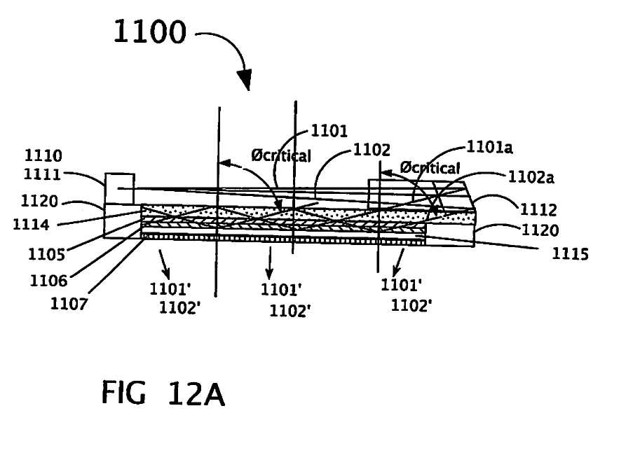

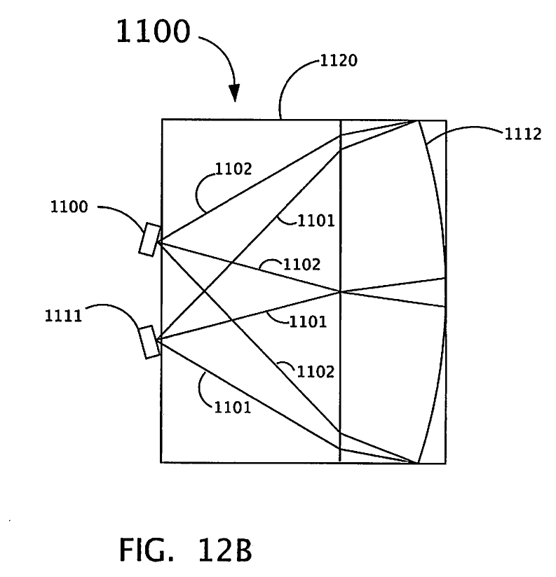

FIGS. 12A and 12B illustrate a directed illumination display device 1100 according to the present disclosure that is configured in an optical arrangement within a case 1120 (see FIG. 12B). In this instance, the directed light beams 1101 a and 1102a are provided in a folded optical path to illuminate the holograms 1105 and 1106. As shown, the folded optical path is formed wherein beams 1101 and 1102 from illumination sources 1110 and 1111 are spread or expanded as beams 1101 and 1102 that pass into prism 1114. The internal faces of prism 1114 may include a curved mirror face 1012 that collimates the beams to re-reflect beyond cutoff, i.e., beyond a critical angle Φ along holograms 1105 and 1106. The light beans are then diffracted along the length of holograms 1105 and 1106 to form the illumination beams 1101′ and 1102′ that illuminate the image display or surface 1107.

The present disclosure also relates to a method of displaying a stereoscopic image and includes the steps of: displaying a first image on a transparent display; illuminating the first image by projecting light onto a first hologram that directs the illumination though the transparent display to focus the first image at a viewing area; terminating the first image display and the illumination of the first image; displaying a second image on the transparent display; illuminating the second image by projecting light onto a second hologram that directs the light through the transparent display and focuses the second image at a second viewing area; and sequentially repeating the above steps at a refresh rate to provide a stereo image to an observer positioned to have one eye in the first viewing area and the other eye positioned in the second viewing area. In one embodiment, the refresh rate of each image is at least 60 Hz.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

1. A display device, comprising:
a surface configured to be illuminated by at least two directed light beams; and
at least one holographic optical element;
wherein the surface is configured and disposed with respect to the at least one holographic optical element to display an autostereo image that is illuminated by the at least two directed light beams wherein the at least one holographic element diffracts the at least two directed light beams to form separate stereo viewing areas.

2. A display device according to claim 1 in which the surface is a light imaging surface that is made from a liquid crystal material.

3. A display device according to claim 1 wherein the surface is configured and oriented with respect to the holographic optical element to display the autostereo image that is illuminated in one of transmission and reflection by the at least two directed light beams.

4. A display device according to claim 1 wherein the at least one holographic optical element includes at least two holographic optical elements that are at least one of bonded together and recorded in the same recording material.

5. A display device according to claim 1 wherein the at least one holographic optical element is at least one of a transmission optical element and a reflection optical element.

6. A display device according to claim 1 wherein said at least one holographic optical element includes at least one multiple holographic element.

7. A display device according to claim 1, wherein the at least one holographic optical element is configured to form at least two viewing areas to allow at least two observers to simultaneously observe the autostereo image.

8. A display device according to claim 1, wherein the at least one holographic optical element is recorded in at least one layer of recording material.

9. A display device according to claim 1, wherein the surface is a light-imaging surface containing the autostereo image and wherein the at least one holographic element is manufactured and oriented so that the at least two directed light beams pass therethrough before passing through the light-imaging surface.

10. A display device according to claim 1, wherein the surface is a light-imaging surface containing the autostereo image and wherein the at least one holographic element is manufactured and oriented so that the at least two directed light beams pass therethrough after passing through the light-imaging surface.

11. A display device according to claim 1, wherein the surface is a light-imaging surface and the at least one holographic optical element is a reflection holographic optical element that reflects the at least two directed light beams through the light-imaging surface.

12. A display device according to claim 1, wherein the surface is a reflecting image surface that reflects the at least two directed light beams through the at least one holographic optical element.

13. A display device according claim 1 wherein the at least one holographic optical element includes at least two holographic optical elements constructed of a different recording material to diffract different wavelength spectrums.

14. display device according to claim 1, further comprising:
at least one of a micro-structured flat panel and a holographic flat panel configured to emit the at least two directed light beams.

15. A display device according to claim 1, further comprising:
a waveguide configured and oriented with respect to the surface and the at least two holographic optical elements, wherein illumination by the at least two directed light beams is generated from multiple reflections formed inside the waveguide and the at least two directed light beams are partially diffracted by the at least one holographic optical element when the at least two directed light beams reflect beyond a cutoff.

16. A display device according to claim 15, wherein the at least two directed light beams repeatedly reflect from the partially diffracting at least one holographic optical element.

17. A display device according to claim 16, wherein the at least one holographic optical element is configured such that the efficiency varies to create uniform illumination along the length thereof.

18. A display device according to claim 1, further comprising:
a lens configured and oriented to spread the at least two directed light beams to the width of the area of the image; and
a curved mirror configured and oriented to collimate the spread of the at least two directed light beams and direct said spread of the at least two directed light beams to the at least one holographic optical element for diffraction thereof by the at least one holographic optical element to form the separate stereo viewing areas.

19. A display device according to claim 1, further comprising:
at least one flat array of directional light sources manufactured and oriented with respect to the surface and the at least one holographic optical element such that the at least two directed light beams originate from the at least one flat array of directional light sources.

20. A display device according to claim 1, wherein the surface and the at least one holographic optical element are configured and oriented with respect to each other to enable the at least two directed light beams to be alternately switched in synchronization with left and right stereo images presented on the surfaces to yield an autostereo view to at least one observer.

21. A method of displaying a stereoscopic image comprising the steps of:
displaying a first image on a transparent display;
illuminating the first image by projecting light onto a first hologram that directs the illumination though the transparent display to focus the first image at a first viewing area;
terminating the first image display and the illumination of the first image;
displaying a second image on the transparent display;
illuminating the second image by projecting light onto a second hologram that directs the light through the transparent display and focuses the second image at a second viewing area; and
sequentially repeating the above steps at a refresh rate to provide a stereo image to an observer positioned to have one eye in the first viewing area and the other eye positioned in the second viewing area.

22. A method according to claim 21 wherein the refresh rate of each image is at least 60 Hz.

23. A method according to claim 22 wherein the method includes the step of:
activating each illumination at the same time that the corresponding image is displayed.

24. A method according to claim 23 wherein the illumination is both synchronized with the corresponding image and refreshed at the same rate as the image.
